(19) United States
(12) Patent Application Publication
(10) Pub. No.: US 2009/0306558 A1
(43) Pub. Date: Dec. 10, 2009

(54) MASSAGE DEVICE FOR A MASSAGE CHAIR

(76) Inventor: Ko-Po Chen, Taichung (TW)

Correspondence Address: RABIN & Berdo, PC, 1101 14TH STREET, NW, SUITE 500, WASHINGTON, DC, 20005, US

(21) Appl. No.: 12/134,482

(22) Filed: Jun. 6, 2008

(51) Int. Cl. A61H 7/00

(52) U.S. Cl. 601/101; 601/98; 601/134

(57) ABSTRACT

The present invention describes the assembly structure of a massage device for a massage chair. The assembly structure includes an assembly frame that is divided into a first, second and third frame region. The first frame region is adapted to receive the assembly of a patting actuator block, the second frame region is adapted to receive the assembly of a sliding actuator block, and the third frame region is adapted to receive the assembly of a kneading actuator block. The massage device formed by the assembly of the different actuator blocks on the assembly frame has a reduced volume, and is easy to disassemble for repair or maintenance.

### BACKGROUND OF THE INVENTION

1. Field of the Invention

The present invention generally relates to a massage device used in a massage chair, and more particularly to an assembly structure that is able to reduce a volume occupied by the massage device.

2. The Prior Arts

Presently, there is an increasing consumer demand for all kinds of healthcare products. As a result of this trend, massage chairs have been developed for home usage. In use, the massage chair may be operated to apply various massage movements on diverse regions of the user's body to relieve fatigue and promote blood circulation. As the design of the massage chair advances, more sophisticated functionalities are developed to provide enhanced massage experience to the user. As a result, the construction of the massage mechanism that is incorporated in the back rest of the massage chair becomes more complex, and requires a larger volume for its assembly. This usually leads to the following disadvantages usually encountered in conventional massage chairs:

(1) The larger volume required for mounting the massage mechanism results in an increased size of the whole massage chair, which may not be compatible with the limited usage space available in urban habitation.

(2) Because the massage mechanism becomes more complex and incorporates more component parts, maintenance and repair operations are more difficult to achieve. In certain conventional constructions, the component parts for the massage device may even be assembled at dispersed positions in the interior of the back rest. As a result, complex and time-consuming disassembly tasks are usually necessary during repair operations, which lengthen the service time.

Conventionally, the massage device in a massage chair has the following three functionalities: (1) the massage device is able to slide up and down to apply a massage action to various regions of the user's back; (2) a core of the massage device usually includes two massage rollers capable of moving toward and away from each other to apply a kneading movement on the user's back; (3) the two rollers in the core of the massage device are able to apply a patting movement on the user's back.

To achieve the foregoing functionalities, the manufacturer must provide the following three structures:

(1) a first actuator structure adapted to slide the massage device up and down so as to push other actuator blocks, wherein the up and down movements are mainly achieved via a screwed shaft or toothed rail;

(2) a second actuator structure adapted to cause the massage rollers to apply a kneading movement, wherein the kneading movement is achieved by a construction that includes an eccentric portion provided on a driven end of a swaying arm coupled to each of the rollers, which enables each of the rollers to perform alternated left and right movements when the driven end rotates; and

(3) a third actuator structure adapted to cause the massage rollers to apply a patting movement, wherein the patting movement is achieved by a construction that includes a multi-axes transmission shaft coupled to each swaying arm and rearward provided with an eccentric portion at a shaft hole region, which enables each massage roller to perform a patting movement.

FIG. 1 illustrates a conventional massage device 90 that may be incorporated in a massage bed. The illustrated structure was also described in U.S. Pat. No. 7,029,453 B2, filed by the same applicant of the present application. The massage device 90 integrates the same three actuating functionalities described above in one frame 91. One side of the frame 91 is mounted with a first actuator block 97 adapted to perform up and down sliding movements. The first actuator block 97 includes a decelerator device 98 configured to cause a transmission shaft to roll and perform up and down movements on a toothed rail 60 via two gears (not shown) coupled to the two ends of the transmission shaft and engaging with the toothed rail 60. A central region of the frame 91 includes a second actuator block 92 adapted to apply kneading movements. The second actuator block 92 includes a decelerator device 93 coupled to a swaying arm that is connected to each set of massage rollers 941 and has an eccentric portion enabling each set of massage rollers 941 to perform kneading movements. Another side of the frame 91 opposite the side of the first actuator block 97 is mounted with a third actuator block 95 adapted to apply patting movements. The third actuator block 95 includes a decelerator device 96 provided with an eccentric portion and coupled to a multi-axes transmission shaft 961. The multi-axes transmission shaft 961 is also coupled to the second actuator block 92, so that the third actuator block 95 can be operated to cause patting movements transmitted to the second actuator block 92.

While the approach illustrated in FIG. 1 attempts to integrate the various actuator blocks in one frame 91, the placement of the different component parts is still dispersed and fails to provide a dense structural assembly that facilitates repair operations.

### SUMMARY OF THE INVENTION

The present invention provides an assembly structure for a massage device of a massage chair that can overcome the foregoing issues of a large volume requirement for receiving a complex structure of the massage device.

In one embodiment, a massage device of a massage chair comprises an assembly frame formed from a plate that is bent to define a first frame region, a second frame region and a third frame region. Each of the frame regions is provided with assembly holes and slots adapted to receive the assembly of one of the kneading actuator block, patting actuator block and sliding actuator block. More particularly, the first frame region receives the assembly of the patting actuator block having the eccentric portion, the axis of a driving motor and the axis of a decelerator device in the patting actuator block positioned parallel and above each other over the first frame region. The second frame region includes a second surface that is offset at a different level from a first surface of the first frame region so as to form a second accommodating space. In a same manner, the third frame region includes a third surface that is offset at a different level from the first surface of the first frame region so as to form a third accommodating space. The second frame region is assembled with the sliding actuator block having two sides respectively provided with a gear and a roller capable of rotating on a toothed rail. In the sliding actuator block, the axis of the driven end of the decelerator device is disposed above the axis of the driving motor, both axes being perpendicular to the second surface. In addition, the axis of the driven end of the decelerator device and the axis of the driving motor in the sliding actuator block respectively pass through assembly openings in the second surface to be received in the second accommodating space. The third frame region is assembled with the kneading actuator block also provided with an eccentric portion. The assembly direction of the kneading actuator block is opposite to that of the sliding actuator block, the driving motor of the kneading actuator block being placed at an upper position whereas its decelerator device is placed at a lower position. In addition, the axes of both the driven end of the decelerator device and the driving motor are also perpendicular to the third surface, and respectively pass through assembly openings in the third surface to be received in the third accommodating space.

The above assembly structure provides at least the following advantages:

(1) The whole massage device can be assembled with the assembly frame with one simple operation performed on a same assembly line, and repair operations are facilitated as the disassembly of the massage device is easier to achieve.

(2) The configuration of the assembly frame enables a symmetrical placement of the patting actuator block, sliding actuator block and kneading actuator block, and also is able to stack the driving motor and the decelerator device of each actuator block in a compact space. Because the assembly volume is used in the most efficient manner, the total volume occupied by the massage device can be effectively reduced.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a conventional structure of a massage device;

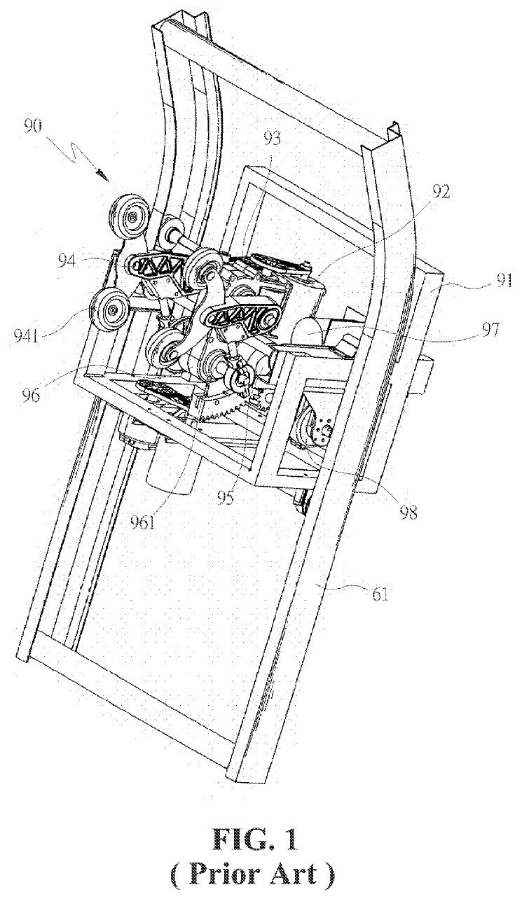

FIG. 2 is a perspective view partially illustrating an assembly structure of a massage device incorporated in a massage chair according to one embodiment of the present invention;

FIG. 3 is an exploded view illustrating an assembly structure of a massage device incorporated in a massage chair according to one embodiment of the present invention;

FIG. 4 is a perspective view illustrating the assembly structure of the massage device according to one embodiment of the present invention;

FIG. 5 is a front view of the assembled massage device according to one embodiment of the present invention;

FIG. 6 is a top view of the assembled massage device according to one embodiment of the present invention;

FIG. 7 is a right side view of the assembled massage device according to one embodiment of the present invention;

FIG. 8 is a rear view of the assembled massage device according to one embodiment of the present invention;

FIG. 9 is a rear perspective view of the assembled massage device according to one embodiment of the present invention; and

FIG. 10 is a perspective view illustrating the massage device incorporated in the back rest of a massage chair according to one embodiment of the present invention.

### DETAILED DESCRIPTION OF THE PREFERRED EMBODIMENT

The following description in conjunction with the accompanying drawings set forth embodiments for achieving a door lock provided with a large handle.

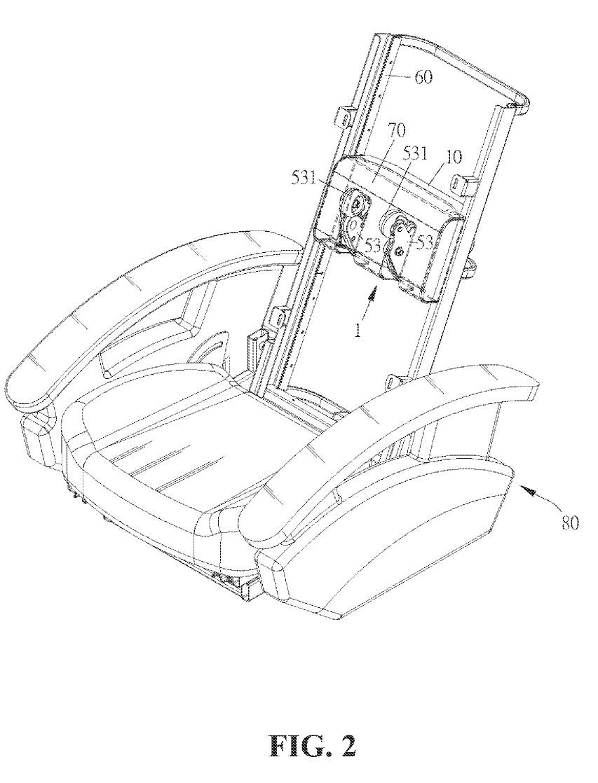

FIG. 2 is a perspective view of the assembly of a massage chair 80. As described previously, the volume occupied by the back rest of the entire massage chair 80 can be reduced when an efficient mounting space is provided for the assembly operation. According to an embodiment of the invention, a massage module 1 of the massage chair 80 is disposed on a toothed rail 60. Driven by a gear, the entire massage module 1 is able to slide up and down on the back rest of the massage chair 80. After the assembly of the massage module 1 is completed, a front end of the massage module 1 has a protective lid 70 provided with two slots through which massage rollers are able to protrude outward to apply a massage action. The protective lid 70 is of a well-known construction whose description is omitted herein.

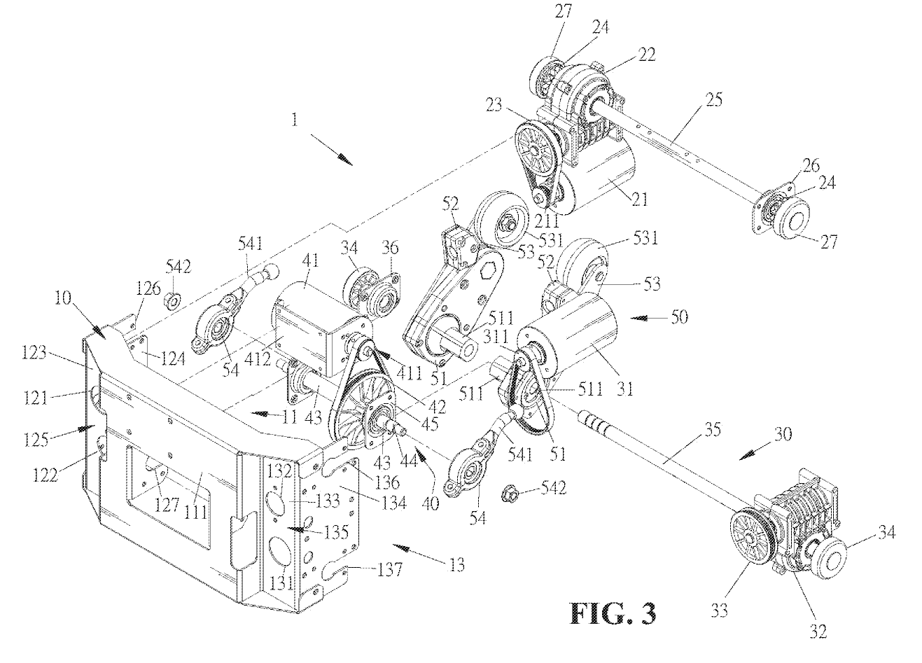

FIG. 3 is an exploded view of an embodiment of the present invention. The present invention includes an assembly frame 10 as main structure. The assembly frame 10 is a generally U-shaped plate comprising a first frame region 11, a second frame region 12 and a third frame region 13. The first frame region 11 has a larger surface area, and includes a first surface 111 provided with a plurality of assembly holes. The second frame region 12 and the third frame region 13 are located at two opposite sides of the first frame region 11. The second frame region 12 includes a set of second surfaces 123/124 defining an L-shaped profile, whereas the third frame region 13 includes a set of third surfaces 133/134 also defining an L-shaped profile. Moreover, the second surface 123 and third surface 133 are located at a level offset from the first surface 111 so as to define a second accommodating space 125 and third accommodating space 135. The second surface 123 and the third surface 133 are also respectively provided with multiple assembly holes and slots. In particular, each of the second surface 123 and third surface 133 respectively includes a first opening 121 and 131 at opposite positions, and a second opening 122 and 132 also located at opposite positions.

When the entire structure is assembled, the first surface 111 is coupled to a patting actuator block 40 having an eccentric portion. The patting actuator block 40 comprises a driving motor 41. The driving motor 41 has a driving end 411, and a bottom coupled to a fixing frame 412. After the driving motor 41 and its driving end 411 are assembled in the fixing frame 412, the assembly of the fixing frame 412 and driving motor 41 are securely mounted on the first surface 111, the axle of the driving motor 41 being parallel with the first surface 111. Furthermore, a decelerator device 42 is disposed below the driving motor 41. The decelerator device 42 includes a shaft 43 having one end portion mounted with a decelerator gear 42 that is coupled to the driving end 411 via a transmission belt. Each of the two distal ends of the shaft 43 is mounted through a bearing 45 used as support during operation. The shaft 43 extends on an outer side of each bearing 45 to form an eccentric portion 44. Each of the two eccentric portions 44 is assembled with a coupling bearing 54 that is in turn connected with a multi-axes transmission shaft 541. The position of the driving motor 41 is arranged above the position of the decelerator device 42 over the first surface 111. An upper side of the second surface 124 of the second frame region 12 is coupled to a sliding actuator block 20 that includes a gear 24 at two lateral sides and is adapted to rotate on the toothed rail 60. An upper side of the sliding actuator block 20 includes a decelerator device 22. An interior of the decelerator device 22 includes the assembly of a rotary screwed shaft (not shown) with a rotary gear (not shown) adapted to transmit a rotation movement at an angle of 90 degrees. The decelerator device 22 also comprises a decelerator gear 23 at a position corresponding to the second surface 123 to cooperate with the rotary screwed shaft and couple to an end of a transmission shaft 25 at an angle of 90 degrees. Examples of the decelerator devices 22/33 are well-known in the prior art, such as those illustrated in U.S. Pat. No. 7,029,453 B2, the disclosure of which is incorporated herein by reference. One end portion of the transmission shaft 25 corresponding to the decelerator device 22 is assembled with a bearing 26. In addition, each of two end portions of the transmission shaft 25 is also assembled with a gear 24 and a roller 27. The bearing 26 is disposed above the surface 134 so as to support the transmission shaft 25. The two distal ends of the transmission shaft 25 are secured through slots 126/136 provided on the second surface 124 and the third surface 134, respectively. The decelerator device 22 is coupled to a driving motor 21 right below the second surface 124. One end of the driving motor 21 corresponding to a decelerator gear 23 is assembled with a driving wheel 211 coupled to the decelerator gear 23 via a transmission belt. The decelerator gear 23 and the driving wheel 211, once mounted on the second surface 124, respectively extend out of the first opening 121 and second opening 122 of the second surface 123 to be received in the second accommodating space 125. The third surface 134 of the third frame region 13 is assembled with a kneading actuator block 30 having an inclined eccentric portion. The placement of component parts for the kneading actuator block 30 is opposite to the placement of component parts for the sliding actuator block 20 on the second frame region. A driving motor 31 of the kneading actuator block 30 is disposed above the third surface 134. One end of the driving motor 31 corresponding to the third surface 133 is coupled to a driving wheel 311 mounted on a decelerator device 32 (similar to the decelerator device 22) right below the third surface 134. One end of the decelerator device 32 corresponding to the driving wheel 311 is assembled with a decelerator gear 33 coupled to the driving wheel 311 via a transmission belt. The driving wheel 311 and the decelerator gear 33, once mounted on the third surface 134, respectively extend out of the second opening 132 and the first opening 131 of the third surface 133 and second surface 124 to be received in the third accommodating space 135. The decelerator device 32 is coupled to a transmission shaft 35 at an angle of 90 degrees. One end of the transmission shaft 35 corresponding to the decelerator device 32 is coupled to a bearing 36. In addition, each of two end portions of the transmission shaft 35 is coupled to a roller 34. The bearing 36 is disposed above the surface 124 so as to support the transmission shaft 35. The two distal ends of the transmission shaft 35 are secured through slots 127/137 provided on the second surface 124 and the third surface 134, respectively.

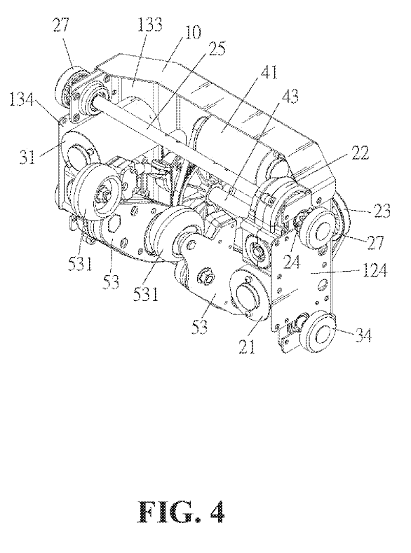

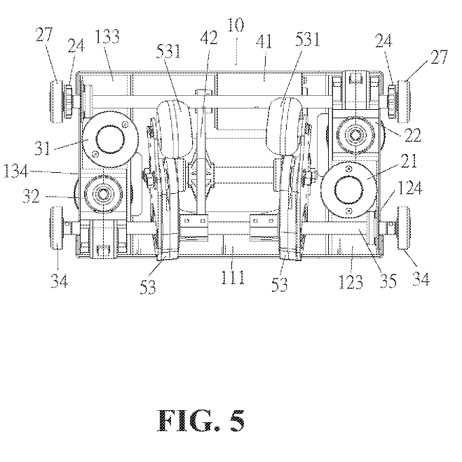

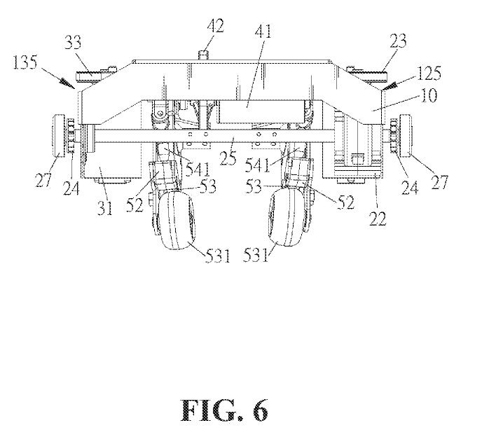

FIGS. 4-6 are schematic views showing an assembled embodiment of the present invention. During operation, the gear 24 and roller 27 at each of the two ends of the sliding actuator block 20 are located in the toothed rail 60 on the back rest of the massage chair 80. Each set of the gear 24 and roller 27 is driven by the driving parts of the sliding actuator block 20 through the gear 24 to cause a sliding movement in the toothed rail 60. The transmission shaft 35 drives a movement of two swaying arms 51 of a massage device 50 that are respectively coupled to two connection regions of the transmission shaft 35 of the kneading actuator block 30. Each connection region between the transmission shaft 35 and one swaying arm 51 is also provided with an inclined eccentric portion 511, placed in a position facing each other. When the transmission shaft 35 rotates, the two inclined eccentric portions 511 are driven to generate inward and outward kneading movements. One end of each swaying arm 51 opposite the inclined eccentric portion 511 is also coupled to an arm 53 and a roller 531. A back massage movement is provided by a combined action of the rolling movement of the roller 531 and the movement of the two swaying arms 51. In addition, a multi-axes link 52 is coupled to a portion of each of the two swaying arms 51. One side of the multi-axes link 52 corresponding to the assembly frame 10 includes a multi-axes link hole 521. Each of the two eccentric portions 44 of the patting actuator block 40 is assembled with a coupling bearing 54 via a fastener nut 542. One end of each coupling bearing 54 is mounted with a multi-axes transmission shaft 541, and is further connected to the multi-axes link hole 521. During rotation, the offset positions of the two eccentric portions 44 cause vibration of the coupling bearings 54, which is transmitted via the transmission shaft 541 to the multi-axes link 52. As a result, the swaying arms 51 are caused to push the rollers 531 forward, thereby creating kneading and patting movements.

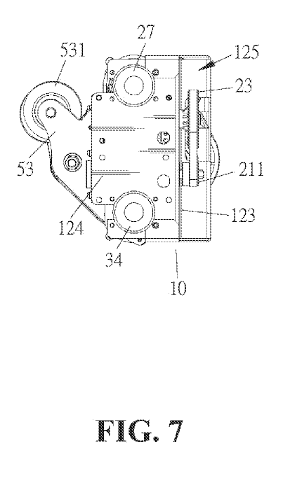

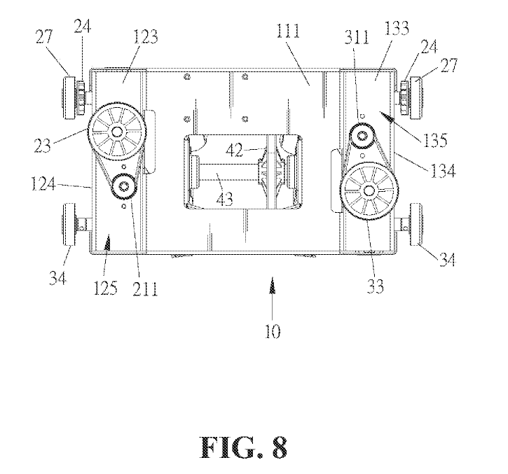

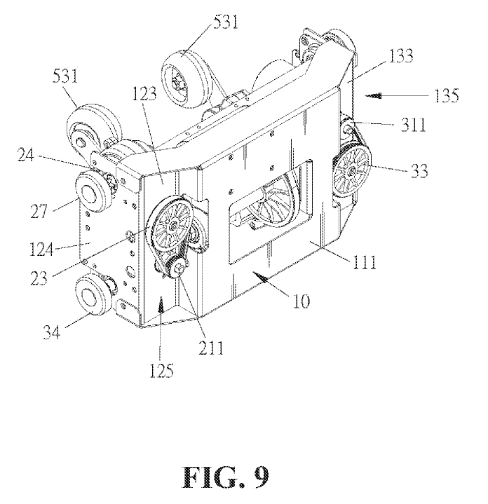

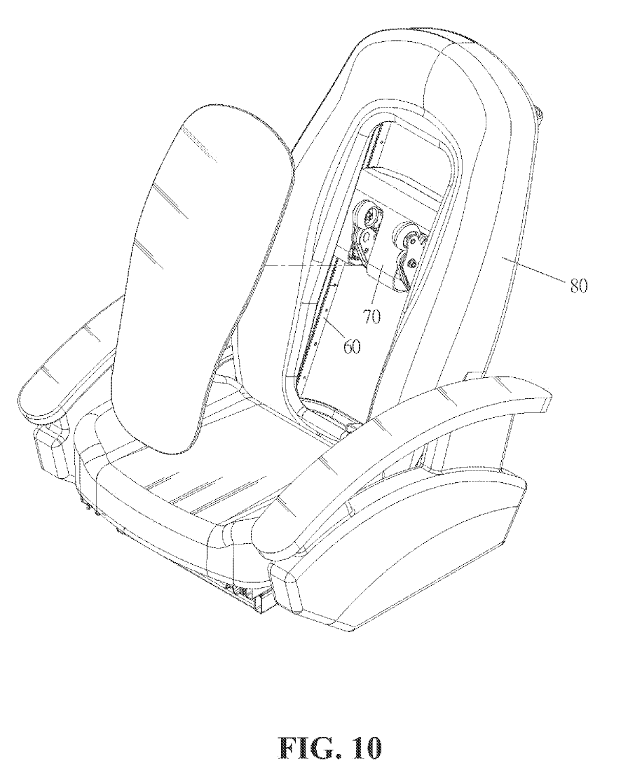

FIGS. 7-9 are various views showing an assembled massage device according to an embodiment of the present invention. The assembly of the massage chair based on the above-described configuration can provide the following advantages. First, the accommodating space provided by the assembly frame 10 can suitably receive each component part of the patting actuator block 40, sliding actuator block 20 and kneading actuator block 30 in a reduced space. More particularly, the configuration of the assembly frame 10 allows a placement of the patting actuator block 40 in a transversal position in the first frame region 11, whereas the sliding actuator block 20 and kneading actuator block 30 can be placed vertically over each other in the second frame region 12 and third frame region 13. As the driving outputs of both the sliding actuator block 20 and kneading actuator block 30 are disposed in a stacked manner in the second accommodating space 125 and third accommodating space 135, the relatively complex mechanical operation of the whole massage device can be performed in a reduced volume space without undesirable interferences. Furthermore, referring to FIG. 10 which shows an assembled configuration of the present invention, all the massage actuating components in the back rest can be simultaneously assembled in a same device within a reduced space. As a result, the volume of the back rest of the massage chair 80 can be advantageously reduced. Second, in addition to the ability to mount all the massage actuating structures simultaneously instead of through multiple assembly operations during the manufacture, the design configuration of the present invention also allows simultaneous removal of the entire device structure for replacement during a repair operation. Because no cumbersome disassembly operations are required, the maintenance and repair operations can therefore be performed in an efficient manner.

As described above, at least one advantage of the placement configuration provided by the present invention is the ability to reduce the assembly volume and facilitate the repair operations.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A massage device for a massage chair, wherein the massage device comprises an assembly frame, a patting actuator block, a sliding actuator block, a kneading actuator block and a massage device, each of the patting actuator block, the sliding actuator block and the kneading actuator block respectively comprises a driving device and a decelerator device; and the massage device comprises a massage actuator block having an inclined eccentric portion and a transmission element having an eccentric portion, wherein:
the assembly frame comprises a first frame region, a second frame region and a third frame region, the first frame region comprises a first surface, the second frame region comprises a second surface, and the third frame region comprises a third surface, each of the first, second and third surface being provided with a plurality of assembly holes, openings and slots, wherein the second surface is offset from the first surface so that the second surface and a rear side of the first surface define a second accommodating space, and the third surface is offset from the first surface so that the third surface and the rear side of the first surface define a third accommodating space;
the patting actuator block comprises a first driving device and a first decelerator device, the first driving device comprises a first driving motor and a first driving end, the first decelerator device comprises a first driven end and a first transmission shaft, wherein a driving axis of each of the first driving device and the first decelerator device is parallel to the first surface, and each of two ends of the first transmission shaft respectively includes an eccentric portion;
the sliding actuator block comprises a second decelerator device and a second driving device, the second decelerator device comprises a second driven end and a second transmission shaft, the second driving device includes a second driving motor and a second driving end, wherein a driving axis of each of the second driving device and the second decelerator device is perpendicular to the second surface and passes through the second surface to be received in the second accommodating space, and each of two ends of the second transmission shaft has a portion adapted to drive the massage device in movement on a back rest of the massage chair;
the kneading actuator block comprises a third driving device and a third decelerator device, the third driving device includes a third driving motor and a third driving end, the third decelerator device includes a third driven end and a third transmission shaft, wherein a driving axis of each of the third driving device and the third decelerator device is perpendicular to the third surface and passes through the third surface to be received in the third accommodating space, and each of two ends of the third transmission shaft has a rotary portion capable of moving on the back rest of the massage chair;
the massage device comprises a massage actuator block provided with an inclined eccentric portion, and a transmission element provided with an eccentric portion, wherein the massage actuator block includes a pair of swaying arms, one front end of each swaying arm being connected to a massage portion, a central portion of each swaying arm having a connecting link, and a rear portion of each swaying arm includes a fourth transmission shaft having an inclined eccentric portion that is coupled to the third transmission shaft of the kneading actuator block, the transmission element with the eccentric portion includes a bearing and a fifth transmission shaft, the bearing is connected to one eccentric portion on the first transmission shaft, one side of the bearing is coupled to the fifth transmission shaft, and another side of the fifth transmission shaft is connected to the link on each swaying arm.

2. The massage device as claimed in claim 1, wherein the second surface and the third surface of the assembly frame are formed from a bent surface having a bent angle, the bent surface being adapted to assemble with two ends of a fixing structure.

3. The massage device as claimed in claim 1, wherein any of the first driving end, the first driven end, the second driving end, the second driven end, the third driving end and the third driven end includes a gear structure adapted to drive a transmission belt in movement.

4. The massage device as claimed in claim 1, wherein the first driving device and the first decelerator device in the patting actuator block are mounted above each other, and the first driving end of the first driving motor and the first driven end of the first decelerator device use a transmission belt as transmission element.

5. The massage device as claimed in claim 1, wherein the second decelerator device and the second driving device in the sliding actuator block are mounted above each other, and the second driving end of the second driving motor and the second driven end of the second decelerator device use a transmission belt as transmission element, and a driving output of the second decelerator device comprises a turned output.

6. The massage device as claimed in claim 1, wherein a transmission end of the second decelerator device in the sliding actuator block comprises the coupling of a gear structure with a roller structure movably mounted on a toothed rail in the back rest.

7. The massage device as claimed in claim 1, wherein the third driving device and the third decelerator device in the kneading actuator block are mounted above each other, and the third driving end of the third driving motor in the third driving device and the third driven end of the third decelerator device use a transmission belt as transmission element, and a driving output of the third decelerator device comprises a turned output.

8. The massage device as claimed in claim 1, wherein a transmission end of the third decelerator device in the kneading actuator block comprises a roller structure movably mounted on a toothed rail in the back rest.

9. The massage device as claimed in claim 1, wherein a front end of each swaying arm in the massage device comprises one or more pair of rollers.

10. The massage device as claimed in claim 1, wherein the link of the massage device comprises a spherical multi-axes link.

11. The massage device as claimed in claim 1, wherein the fifth transmission shaft of the massage device comprises a spherical multi-axes link.
